(19) United States
(12) Patent Application Publication
(10) Pub. No.: US 2013/0340307 A1
(43) Pub. Date: Dec. 26, 2013

(54) PLURALITY OF SPORT TEAM TILES

(71) Applicants: Lotan LaPlume, St. Jospeh, MI (US); Nick Saginiario, Rindge, NH (US)

(72) Inventors: Lotan LaPlume, St. Jospeh, MI (US); Nick Saginiario, Rindge, NH (US)

(21) Appl. No.: 13/528,740

(22) Filed: Jun. 20, 2012

(51) Int. Cl. G09F 7/00

(52) U.S. Cl. 40/584

(57) ABSTRACT

The present invention is a plurality of sport team tiles. The sport team tiles include a college sports team tile, a professional football franchise team tile and a professional basketball franchise team tile. The tiles all include a base tile with a top surface and a first indicia disposed on the top surface of the base file, said first indicia represents a college sports team.

### TECHNICAL FIELD & BACKGROUND

If an individual desires to display support of their favorite sports team with embellishments placed throughout their home or office, they would have to be made special order. It can be expensive and time consuming to purchase and create tiles made with a specific design.

The present invention generally relates to a plurality of tiles. More specifically, the invention is a plurality of sport team tiles.

It is an object of the invention to provide a plurality of sport team tiles that can be utilized on a plurality of different types of surfaces such as floors, walls, bars and countertops.

It is an object of the invention to provide a plurality of sport team tiles that can be utilized in a sports bar, a home, one or more colleges and universities and one or more sports franchises.

It is an object of the invention to provide a plurality of sport team tiles that includes professional and college sports teams for a wide variety of sports such as football, baseball, basketball and other major sports.

What is really needed is a plurality of sport team tiles that can be utilized on a plurality of different types of surfaces such as floors, walls, bars and countertops that can be utilized in a sports bar, a home, one or more colleges and universities and one or more sports franchises that includes professional and college sports teams for a wide variety of sports such as football, baseball, basketball and other major sports.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front perspective view of a college sports team tile of a plurality of sport team tiles, according to an embodiment of the present invention.

FIG. 2 illustrates a front view of a professional football franchise team tile of a plurality of sport team tiles, according to an embodiment of the present invention.

FIG. 3 illustrates a front view of a professional basketball franchise team tile of a plurality of sport team tiles, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

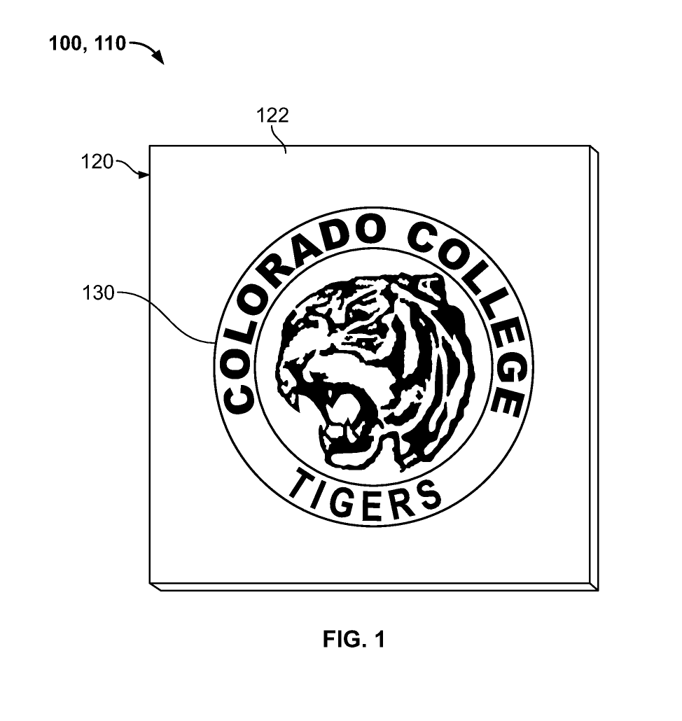

FIG. 1 illustrates a front perspective view of a college sports team tile 110 of a plurality of sport team tiles 100, according to an embodiment of the present invention. The plurality of sport team tiles 100 can include professional and college sports teams for a wide variety of sports such as football, baseball, basketball and other suitable major sports. The plurality of sport team tiles 100 can be packaged in a set of approximately 20 sport team tiles or any other suitable number of tiles.

The college sports team tile 110 includes a base tile 120 and an indicia 130. The base tile 120 has a top surface 122 and serves as a foundation of the college sports team tile 110. The base tile 120 can be made of vinyl, ceramic, linoleum or any other suitable material. The base tile 120 can be approximately 16 inches by 16 inches, 14 inches by 14 inches, 12 inches by 12 inches, 10 inches by 10 inches, 8 inches by 8 inches, 6 inches by 6 inches, 4 inches by 4 inches in dimension or any other suitable dimension. The indicia 130 is disposed on the top surface 122 of the base file 120 and can represent any suitable college sports team. The college sports team illustrated in FIG. 1 is the Colorado College Tigers.

The college sports team tile 110 can be utilized on a plurality of different types of surfaces such as floors, walls, bars and countertops and any other suitable surface. The college sports team tile 110 can be utilized in a sports bar, a home, one or more colleges and universities and one or more sports franchises or any other suitable location. The college sports team tile 110 can be attached to any flat vinyl, ceramic or linoleum surface with any suitable vinyl, ceramic or linoleum adhesive or attachment method.

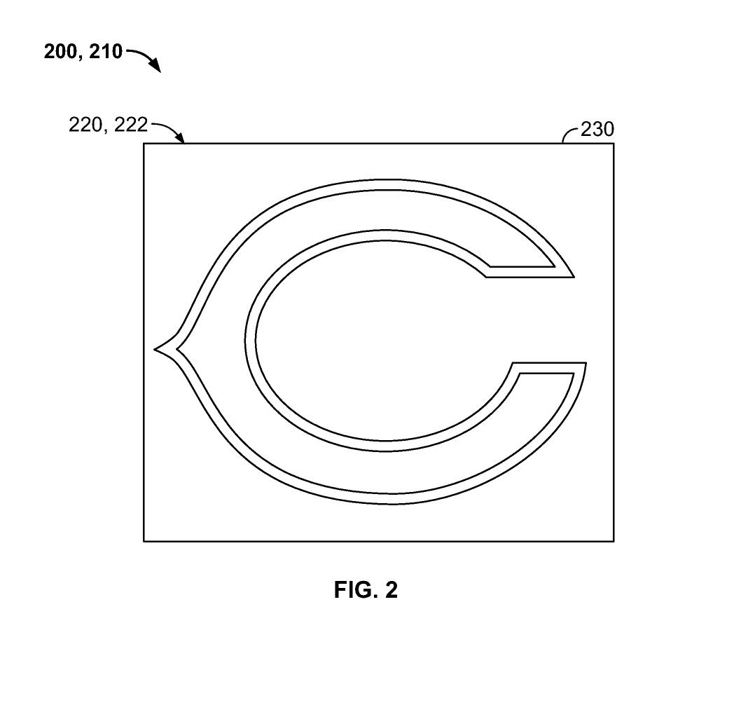

FIG. 2 illustrates a front view of a professional football franchise team tile 210 of a plurality of sport team tiles 200, according to an embodiment of the present invention.

The professional football franchise team tile 210 includes a base tile 220 and an indicia 230. The base tile 220 has a top surface 222 and serves as a foundation of the professional football franchise team tile 210. The base tile 220 can be made of vinyl, ceramic, linoleum or any other suitable material. The base tile 220 can be approximately 16 inches by 16 inches, 14 inches by 14 inches, 12 inches by 12 inches, 10 inches by 10 inches, 8 inches by 8 inches, 6 inches by 6 inches, 4 inches by 4 inches in dimension or any other suitable dimension. The indicia 230 is disposed on the top surface 222 of the base file 220 and can represent any suitable college sports team. The professional football franchise team illustrated in FIG. 2 is the Chicago Bears.

The professional football franchise team tile 210 can be utilized on a plurality of different types of surfaces such as floors, walls, bars and countertops and any other suitable surface. The professional football franchise team tile 210 can be utilized in a sports bar, a home, one or more colleges and universities and one or more sports franchises or any other suitable location. The professional football franchise team tile 210 can be attached to any flat vinyl, ceramic or linoleum surface with any suitable vinyl, ceramic or linoleum adhesive or attachment method.

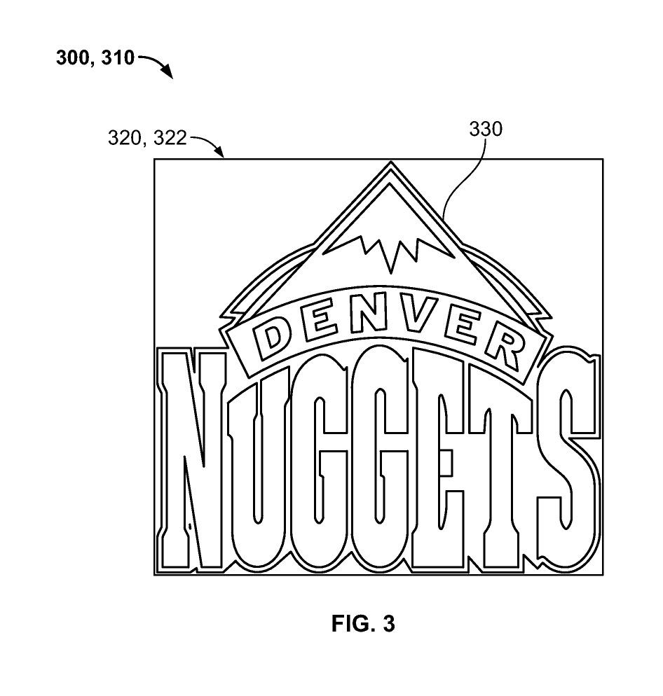

FIG. 3 illustrates a front view of a professional basketball franchise team tile 310 of a plurality of sport team tiles 300, according to an embodiment of the present invention.

The professional basketball franchise team tile 310 includes a base tile 320 and an indicia 330. The base tile 320 has a top surface 322 and serves as a foundation of the professional basketball franchise team tile 310. The base tile 320 can be made of vinyl, ceramic, linoleum or any other suitable material. The base tile 320 can be approximately 16 inches by 16 inches, 14 inches by 14 inches, 12 inches by 12 inches, 10 inches by 10 inches, 8 inches by 8 inches, 6 inches by 6 inches, 4 inches by 4 inches in dimension or any other suitable dimension. The indicia 330 is disposed on the top surface 322 of the base file 320 and can represent any suitable college sports team. The professional basketball franchise team illustrated in FIG. 3 is the Denver Nuggets.

The professional basketball franchise team tile 310 can be utilized on a plurality of different types of surfaces such as floors, walls, bars and countertops and any other suitable surface. The professional basketball franchise team tile 310 can be utilized in a sports bar, a home, one or more colleges and universities and one or more sports franchises or any other suitable location. The professional basketball franchise team tile 310 can be attached to any flat vinyl, ceramic or linoleum surface with any suitable vinyl, ceramic or linoleum adhesive or attachment method.

The plurality of sports tiles have a surface decorated with a collegiate or professional team franchise logo. Made of vinyl, ceramic or linoleum, the plurality of sports tiles may be placed on most indoor or outdoor surfaces. Consumers may have a choice of a set of approximately 20 tiles in either an approximate 12 inch x 12 inch, an approximate 16 inch x 16 inch size or other suitable size which can be used to decorate a floor, a wall, a countertop or other suitable surface. The plurality of sports tiles may be readily available at retail stores where home improvement items are sold. The plurality of sports tiles feature the logos of collegiate and professional teams such as the Chicago Bears, the Denver Nuggets and the Colorado College Tigers, affixed to the top surface of the plurality of sports tiles. The plurality of sports tiles are designed to be placed on a wide variety of surfaces, such as a floor of a bathroom, a countertop in a restaurant and other suitable surfaces.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A college sports team tile, comprising:
a base tile with a top surface, wherein said base tile serves as a foundation of said college sports team tile and said base tile is adapted to be attached to any flat vinyl, ceramic or linoleum surface; and
a first indicia disposed on said top surface of said base file, said first indicia represents a college sports team.

2. The college sports team tile according to claim 1, wherein said base tile is made of vinyl.

3. The college sports team tile according to claim 1, wherein said base tile is made of ceramic.

4. The college sports team tile according to claim 1, wherein said base tile is made of linoleum.

5. The college sports team tile according to claim 1, wherein said base tile is approximately 16 inches by 16 inches.

6. The college sports team tile according to claim 1, wherein said base tile is approximately 12 inches by 12 inches.

7. The college sports team tile according to claim 1, wherein said college sports team tile is packaged together in approximately 20 said college sports team tiles.

8. A professional football franchise team tile, comprising:
a base tile with a top surface, wherein said base tile serves as a foundation of said professional football franchise team tile and said base tile is adapted to be attached to any flat vinyl, ceramic or linoleum surface; and
a first indicia disposed on said top surface of said base file, said first indicia represents a professional football franchise team.

9. The professional football franchise team tile according to claim 8, wherein said base tile is made of vinyl.

10. The professional football franchise team tile according to claim 8, wherein said base tile is made of ceramic.

11. The professional football franchise team tile according to claim 8, wherein said base tile is made of linoleum.

12. The professional football franchise team tile according to claim 8, wherein said base tile is approximately 16 inches by 16 inches.

13. The professional football franchise team tile according to claim 8, wherein said base tile is approximately 12 inches by 12 inches.

14. The professional football franchise team tile according to claim 8, wherein said college sports team tile is packaged together in approximately 20 said college sports team tiles.

15. A professional basketball franchise team tile, comprising:
a base tile with a top surface, wherein said base tile serves as a foundation of said professional basketball franchise team tile and said base tile is adapted to be attached to any flat vinyl, ceramic or linoleum surface; and
a first indicia disposed on said top surface of said base file, said first indicia represents a professional basketball franchise team.

16. The professional basketball franchise team tile according to claim 15, wherein said base tile is made of vinyl.

17. The professional basketball franchise team tile according to claim 15, wherein said base tile is made of ceramic.

18. The professional basketball franchise team tile according to claim 15, wherein said base tile is made of linoleum.

19. The professional basketball franchise team tile according to claim 15, wherein said base tile is approximately 16 inches by 16 inches.

20. The professional basketball franchise team tile according to claim 15, wherein said base tile is approximately 12 inches by 12 inches.
